(19) United States
(12) Patent Application Publication
(10) Pub. No.: US 2010/0030988 A1
(43) Pub. Date: Feb. 4, 2010

(54) VIRTUALIZING SWITCH AND COMPUTER SYSTEM

(75) Inventors: Toshiaki TAKEUCHI, Kawasaki (JP); Masakazu Sakamoto, Kawasaki (JP); Takuya Kurihara, Kawasaki (JP); Atsushi Shinohara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/512,244

(22) Filed: Jul. 30, 2009

(30) Foreign Application Priority Data
Jul. 31, 2008 (JP) 2008-197249

(51) Int. Cl. G06F 12/16; G06F 13/00; G06F 12/02

(52) U.S. Cl. 711/162; 711/173; 711/E12.001; 711/E12.002

(57) ABSTRACT

A virtualizing switch includes a storage virtualizing section for making the host computer recognize storage areas prepared by combining storage areas of a physical storage devices as virtual storage devices, a data copying section for executing data copying between the virtual storage devices, a range locking section for dividing a storage area for storing data to be copied of a virtual storage device of a copy source into storage area parts having a previously set division size and inhibiting access to a divided storage area part, an instruction number counting section for counting the number of access instructions to the divided storage area part that is inhibited by the range locking section, and a divided capacity changing section for changing the division size based on the number of instructions counted by the instruction number counting section.

### CROSS-REFERENCE TO RELATED APPLICATIONS

This application is based upon and claims the benefit of priority of the prior Japanese Patent Application No. 2008-197249, filed on Jul. 31, 2008, the entire contents of which are incorporated herein by reference.

### FIELD

Various embodiments described herein relate to a virtualizing switch capable of being connected respectively to a host computer and physical storage devices, and a computer system using the virtualizing switch.

### BACKGROUND

In a computer system using a plurality of storage devices, virtualization of storage for making a host computer recognize a storage area prepared by combining storage areas of a plurality of physical storage devices with one another as a virtual storage device is known.

For example, as illustrated in FIG. 7, there is known a computer system in which a plurality of host computers (node devices) 1 and a plurality of physical storage devices 2 are connected together via a fibre channel switch (a virtualizing switch) 3, some or all of storage areas of the plurality of physical storage devices 2 are combined with one another to configure a virtual storage device (a virtual sharing disk) 5 using a network processor 4 installed in the fibre channel switch 3 and the virtual storage device 5 is accessibly provided to the host computers 1.

Due to storage virtualization realized by using the fibre channel switch as mentioned above, a user can freely build a virtual storage device suitable for the application of each host computer, and the host computer is allowed to use each physical storage device by accessing the virtual storage device concerned with no consideration of the storage capacity and connection form of each physical storage device.

In addition, in the fibre channel switch, data copying is sometimes executed between virtual storage devices. Data copying between the virtual storage devices in the fibre channel switch is typically executed using a DPC (Data Path Controller) installed in a connection port connected to a fibre channel.

However, when a data writing instruction is given from the host computer while data copying is being executed between the virtual storage devices, conflict of data copying with data writing occurs (for example, see Japanese Laid-Open Patent Publication No. 07-084847).

The conflict of data copying with data writing causes problems as shown in FIG. 8. In FIG. 8, the order in which data flows is shown by numerals in parentheses.

That is, it is supposed that the fibre channel switch 3 has received an instruction to copy data between virtual storage devices 5a and 5b (1). Note that the instruction the fibre channel switch 3 received is an instruction to copy data A from the virtual storage device 5a to the virtual storage device 5b. In this situation, it is supposed that a data writing instruction has been transmitted from the host computer 1 to the virtual storage device 5a before copying of the data A from the virtual storage device 5a to the virtual storage device 5b has been completed (2). Note that the instruction transmitted to the virtual storage device 5a is an instruction to write data B into a volume which partially or fully overlaps a volume into which the data A is stored.

As a result, notwithstanding that data copying is still being executed, the data B is written on the volumes concerned of the virtual storage device 5a as a copy sender (hereinafter, referred to as a copy source) and the virtual storage device 5b as a copy receiver (hereinafter, referred to as a copy sink)(3).

If the data A is to be still copied to the volume of the virtual storage device 5b as the copy sink after the data B has been written on the volume, the data A is erroneously copied on the data B written on the volume concerned of the virtual storage device 5b as the copy sink (4), although the data B is written on the volume of the virtual storage device 5a as the copy source. As a result, data of the content that is different from the content that the user has indicated is stored, in particular, in the virtual storage device 5b as the copy sink.

Thus, to exclusively control so as not to execute later indicated processing while predetermined processing such as data copying is being executed among a plurality of virtual storage devices has been conventionally known (see, for example, Japanese Laid-Open Patent Publication No. 2003-084917).

As shown in FIG. 9, in a computer system implementing virtual storage devices, a fibre channel switch 3 is typically constituted by one set of two switches and a data route installed between a host computer 1 and a physical storage device 2 is doubled (made redundant).

In addition, these two fibre channel switches 3 are respectively provided with virtual storage devices for storing the same content of data in order to prevent data from being lost even when any one of the switches goes down.

Each of the fibre channel switches 3 is connected to the host computer 1 via a fibre channel FC so as to be communicable with the computer. Each of the fibre channel switches 3 is also connected to the physical storage device 2 via the fibre channel FC so as to be communicable with the physical storage device. Both the fibre channel switches are connected together via a LAN line so as to be communicable with each other.

Next, the case where exclusive control is performed so as not to execute later indicated processing while certain processing is being executed in the computer system provided with two fibre channel switches 3 as mentioned above will be described.

In exclusive control performed so as not to execute the later indicated processing in the computer system constituting the virtual storage devices, it can be conceived to execute control (hereinafter, referred to as “range locking” in some cases) to inhibit access to a volume on the basis of a later given indication and to put the indication given from the host computer 1 on standby.

In addition, in the case that two fibre channel switches 3 are installed, range-locking has to be executed in both of two fibre channel switches 3.

A method of executing range-locking in both of two fibre channel switches 3 is as follows. The range-locking is executed as shown in FIG. 10.

First, in the case that one fibre channel switch VSCE 1 intends to start execution of data copying in between two virtual storage devices in the fibre channel switch VSCE 1, one fibre channel switch VSCE 1 transmits a volume to be range-locked to another fibre channel switch VSCE 2 via a LAN line.

The fibre channel switch VSCE 2 range-locks the volume to be range-locked that has been received from the fibre channel switch VSCE 1. Thus, both the fibre channel switches are in a range-locked state in which, even when a data writing instruction is given to a volume in which data to be copied is stored, the data writing instruction is put on standby without writing data into the volume concerned until data-copying to the volume is completed.

Incidentally, in the case that a volume to be range-locked is extremely large, the data writing instruction is put on standby for a long time period and there is a possibility that data-writing is not executed because the time has run out.

Thus, it becomes necessary to divide the volume to be range-locked into not so large parts.

That is, the fibre channel switch VSCE 1 communicates with the fibre channel switch VSCE 2 via the LAN line so as to divide a target volume into parts on the basis of the size of data to be copied and to range-lock a divided volume part and then communicates with the fibre channel switch VSCE 2 via the LAN line so as to release range-locking set on the divided volume part concerned at the completion of data-copying thereon. Then, the fibre channel switch VSCE 1 range-locks the next divided volume part and communicates with the fibre channel switch VSCE 2 via the LAN line so as to range-lock the next divided volume part. At the completion of data-copying on the next divided volume part, the fibre channel switch VSCE 1 communicates with the fibre channel switch VSCE 2 via the LAN line so as to release range-locking set on the volume part concerned.

As described above, in the computer system provided with two fibre channel switches for redundancy, a plurality of range-locking operations have to be performed in order to put a data writing instruction given from the host computer 1 on standby while a data copying operation is being executed and every time the range-rocking operation is performed, the fibre channel switches 3 and 3 communicate with each other via the LAN line.

As described above, the conventional computer system has such problems that resources are used for communication processing due to LAN-communication frequently performed while data is being copied and hence the copying performance is deteriorated and the copying operation takes much time.

In addition, even though the range of the volume to be range-locked is increased so as not to frequently perform LAN-communication, such a problem will occur that the standby time of the data writing instruction given from the host computer is increased accordingly.

### SUMMARY

A virtualizing switch includes a storage virtualizing section making the host computer recognize storage areas prepared by combining together some or all of storage areas of the physical storage devices as a plurality of virtual storage devices, a data copying section executing data copying between the virtual storage devices, a range locking section dividing a storage area for storing data to be copied of a virtual storage device of a copy source into storage area parts having a previously set division size and inhibiting access to a divided storage area part concerned when the data copying unit executes data copying between the virtual storage devices, an instruction number counting section counting the number of access instructions from the host computer to the divided storage area part to which access is inhibited by the range locking section, and a divided capacity changing section changing the division size based on the number of instructions counted by the instruction number counting section.

A virtualizing switch controlling method includes executing data copying among a plurality of virtual storage devices prepared using some or all of storage areas of physical storage devices, dividing a storage area for storing data to be copied in a virtual storage device of a copy source into storage area parts having a previously set division size when data copying is executed between virtual storage devices, inhibiting access from the host computer to a divided storage area part concerned, counting the number of access instructions given from the host computer to the divided storage area part to which access has been inhibited, and changing the division size based on the counted number of instructions.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 illustrates a configuration of a computer system according to an embodiment of the present invention;

FIG. 2 illustrates a configuration of a virtual switch (a fibre channel switch) according to an embodiment of the present invention;

FIG. 3 illustrates data-copying and range-locking operations performed using virtual switches according to an embodiment of the present invention;

FIG. 4 illustrates operations performed following the operations illustrated in FIG. 3;

FIG. 5 illustrates operations performed following the operations illustrated in FIG. 4;

FIG. 6 illustrates operations performed following the operations illustrated in FIG. 5;

FIG. 7 illustrates a system configuration of a computer system using a conventional virtual switch;

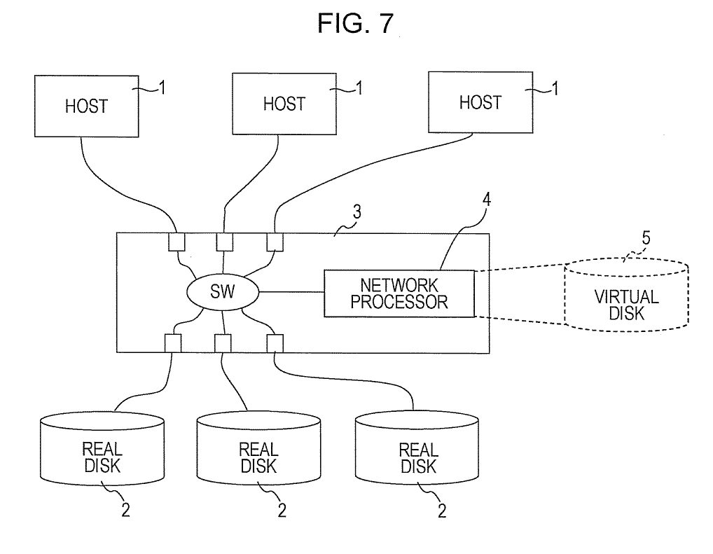

FIG. 8 illustrates conflict of data-copying with data-writing in a conventional computer system;

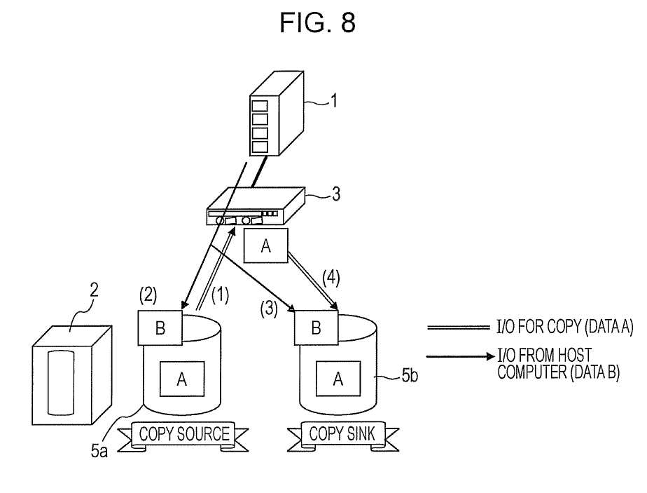

FIG. 9 illustrates a configuration of a computer system using two virtual switches; and

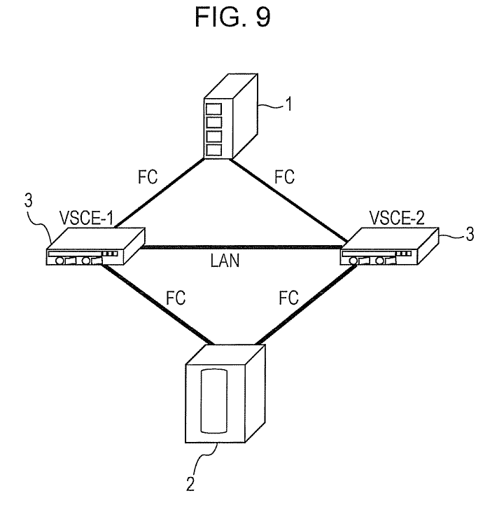

FIG. 10 illustrates exclusive control performed to avoid conflict of data-copying with data-writing in a computer system using two virtual switches.

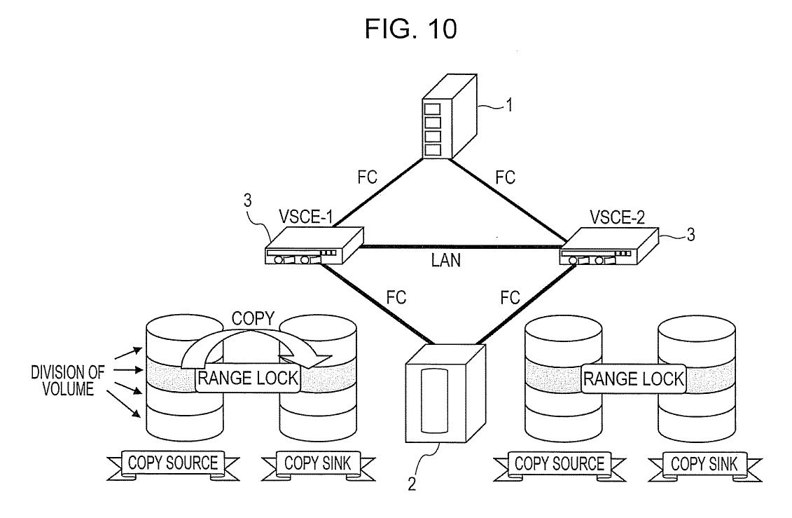

### DESCRIPTION OF EMBODIMENTS

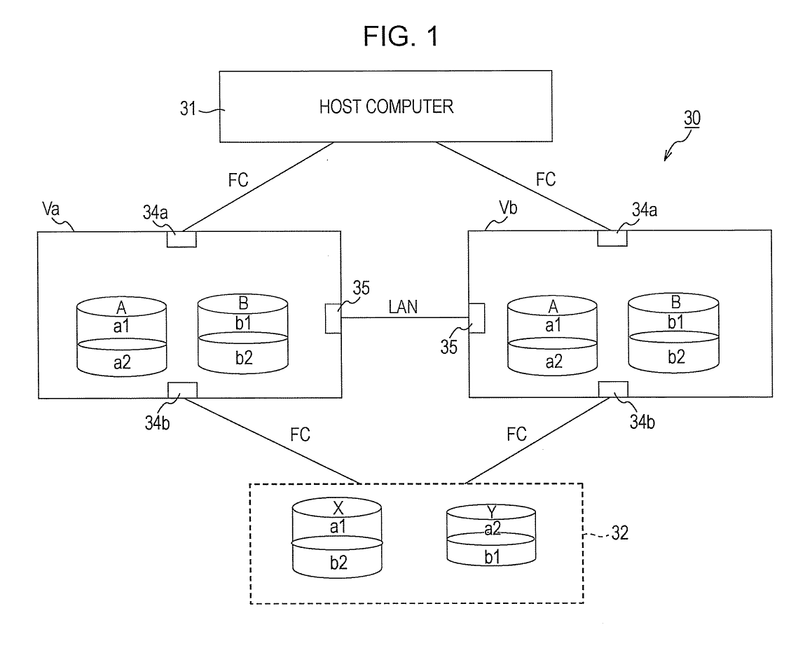

FIG. 1 illustrates a configuration of a computer system according to an embodiment of the present invention. Next, a configuration of the computer system will be described with reference to FIG. 1.

In a computer system 30 of the embodiment, two fibre channel switches Va and Vb (virtual switches) are connected to one host computer 31 via fibre channels FCs (communication lines). Each of the fibre channel switches Va and Vb is connected to an RAID storage device 32 having two physical storage devices X and Y via the fibre channel FC.

The fibre channel switches Va and Vb are connected to each other via a LAN line. As an example of the LAN line, Ethernet (a registered trademark) can be given.

The fibre channel switches Va and Vb are capable of making the host computer 31 recognize virtual storage devices.

In this embodiment, the fibre channel switches Va and Vb operate to combine a part “a1” of the physical storage device X with a part “a2” of the physical storage device Y to configure a virtual storage device A, and combine a part “b1” of the physical storage device Y with a part “b2” of the physical storage device X to configure a virtual storage device B.

The fibre channel switches Va and Vb provide the virtual storage devices A and B configured in such a manner that the host computer 31 connected thereto is accessible thereto. The fibre channel switches Va and Vb respectively include virtual storage devices for storing the same data for promoting data redundancy such that even if any one of the fibre channel switches goes down or any one of communication lines enters an incommunicable state, the host computer can access data without causing data loss.

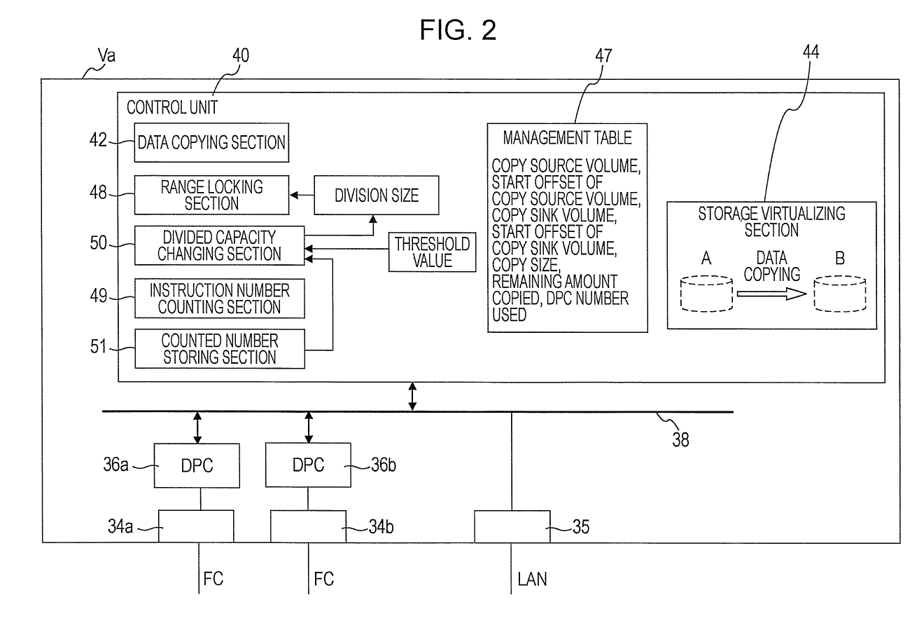

Next, an embodiment of the fibre channel switch Va will be described with reference to FIG. 2. FIG. 2 illustrates a configuration of the fibre channel switch Va according to the embodiment.

The fibre channel switch Va includes a plurality of fibre channel connecting terminals 34a and 34b that can be respectively connected to the host computer 31 and the RAID storage device 32 via the fibre channels FC.

The fibre channel connecting terminals 34a and 34b are respectively provided with DPCs 36a and 36b for executing control of communication lines in a one-to-one correspondence. The DPCs 36a and 36b have a function of executing a data copying process between the virtual storage devices A and B.

The DPCs 36a and 36b are connected together via an internal bus 38 so as to be communicable with each other.

Coaxial cables for handling the fibre channels FCs or fibre channel cables constituted by optical fibre cables may be connected to the fibre channel connection terminals 34a and 34b. The host computer 31 and the RAID storage device 32 are connected to the fibre channel connecting terminals 34a and 34b via the fibre channel cables.

The fibre channel switch Va includes a LAN connecting terminal 35 (an inter-virtualizing-switch communication line connecting unit) that can be LAN-connected to the other fibre channel switch Vb. In this embodiment, Ethernet is adopted as the LAN communication standard. In Ethernet, in general, a cable for communication via Ethernet such as a coaxial cable or a twisted-pair cable is used and the LAN connecting terminal 35 is provided to allow connection of the cable for communication via Ethernet as mentioned above.

The fibre channel switch Va includes a control unit 40 in which a CPU, other LSIs and memories are installed. The control unit 40 is capable of realizing the operations of a storage virtualizing section 44 by executing firmware programs stored in a ROM and functions of the LSIs using the CPU.

The storage virtualizing section 44 provides the host computer 31 with storage areas prepared by combining together some of storage areas of the physical storage devices X and Y connected thereto via the fibre channel connecting terminal 34b as the virtual storage devices A and B as illustrated by the example in FIG. 1. Note that the configuration of the virtual storage device implemented using the fibre channel switch Va is not limited to that in the example illustrated in FIG. 2 and a virtual storage device may be configured by freely combining together all or some of storage areas of a large number of physical storage devices connected to the fibre channel switch.

The storage virtualizing section 44 accesses corresponding areas of the physical storage devices X and Y via the fibre channel connecting terminals 34 based on access signals to the virtual storage devices A and B that are input from the host computer 31 via the fibre channel connection terminal 34a.

The control unit 40 also includes a data copying section 42 and a range locking section 48.

The data copying section 42 allocates a copy session for copying data from a virtual storage device of a copy source to a virtual storage device of a copy sink to any one of the DPCs 36a and 36b based on an instruction given from the host computer 31 and executes control of the DPC to which the copy session has been allocated. Such a data copying section 42 is implemented by reading out and executing a data copying control program stored in a storage unit (not shown) of the fibre channel switch Va using the control unit 40.

In addition, a management table 47 used for managing copy volumes and others is installed in a memory area within the control unit 40.

Information relating to data-copying such as a copy size, a copy source volume, a copy sink volume, a start offset (a start position) of the copy source volume and a start offset (a start position) of the copy sink volume is prepared and stored in the management table 47 for each copying operation.

The range locking section 48 has a function to put a data writing instruction on standby in the case that the data writing instruction has been given from the host computer 31 while data-copying is being executed between the virtual storage devices A and B. For example, in the case that a volume (an area) where data-copying is being executed coincides with a volume of a data writing destination to which the data writing instruction has been given, the range locking section 48 puts the later arrived data writing instruction on standby in order to avoid conflict between the instructions.

Such a range locking section 48 is implemented by reading and executing an exclusive control program stored in a storage unit (not shown) of the fibre channel switch Va.

A range locking operation will be described in more detail. When a data copying instruction has been received from the host computer 31, the range locking section 48 reads out a start offset of a volume of data to be copied in accordance with the data copying instruction and an end offset of the volume thereof from the virtual storage device of a copy source.

Then, the range locking section 48 divides a range to be copied into parts so as to have a previously set division size based on the start offset and the end offset of the volume so read-out. That is, the number of divided parts of a range to be copied differs depending on the data size (capacity) to be copied. The division size is stored in a memory area of the control unit 40.

The range locking section 48 operates such that, when a data writing instruction has been given while data-copying is being executed, the data writing instruction is put on standby so as not to access a divided volume part concerned for each of the divided volume parts, that is, range-locking is performed on the volume part concerned.

The data copying section 42 operates to execute data-copying in units of volume parts divided using the range locking section 48. At the completion of data-copying on one divided volume part, the range locking section 48 releases range-locking on the divided volume part for which execution of data-copying has been completed so as to be accessible thereto.

Then, the data copying section 42 operates to execute data-copying on the next divided volume part, and the range locking section 48 puts a data writing instruction on standby so as not to be accessible to the next divided volume part even though the data writing instruction is given to the next divided volume part.

The control unit 40 also includes an instruction number counting section 49 for counting the number of data writing instructions put on standby in the case that an instruction is put on standby so as not to be accessible to the volume part concerned, that is, the data writing instruction is given to the volume part that has been range-locked.

The instruction number counting section 49 is implemented by detecting interruption using the control section 40 and the counted number of data writing instructions is stored in a memory area of the control unit 40 serving as a counted number storing section 51.

The control unit 40 further includes a divided capacity changing section 50 for comparing the number of instructions counted by the instruction number counting section 49 with a previously set threshold value to increase the division size obtained when initial division is performed in the case that the number of instructions is less than the threshold value, or to decrease the division size in the case that the number of instructions is more than the threshold value.

At the completion of one copying operation, the divided capacity changing section 50 changes the divided size stored in a memory area (not shown) of the control unit 40 in the above mentioned manner.

Such a divided capacity changing section 50 is implemented by reading and executing a divided capacity changing program stored in a storage unit (not shown) of the fibre channel switch Va.

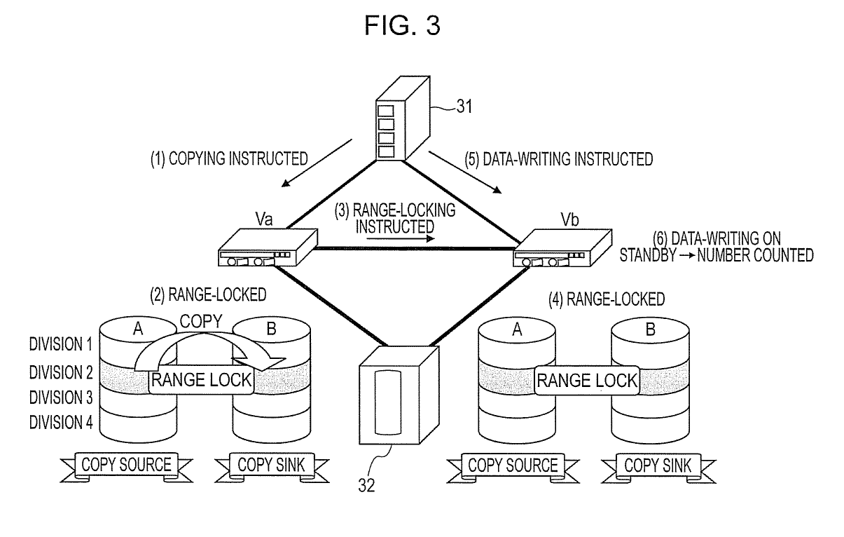

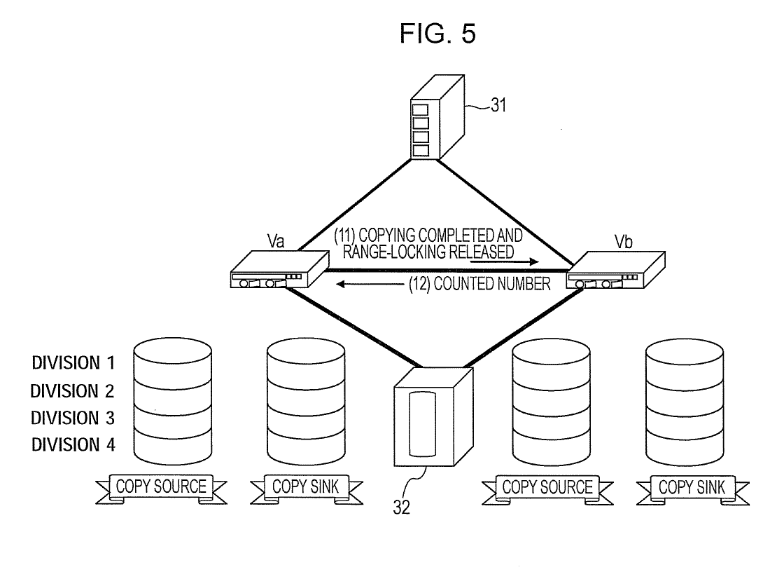

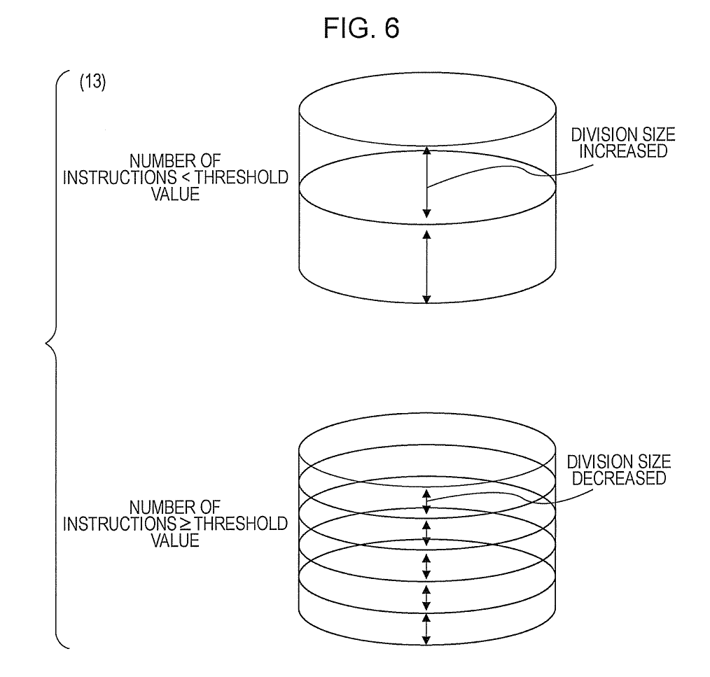

Next, the operations executed upon data copying in the computer system of the configuration as mentioned above will be described with reference to FIGS. 3 to 6. Note that the numerals in parentheses indicate the order in which the following operations are performed.

(1) First, it is supposed that the host computer 31 has transmitted an instruction to copy data between the virtual storage devices A and B to the virtual channel switch Va.

(2) The control unit 40 of the fibre channel switch Va that has received the data copying instruction reads out the start offset of the volume of data to be copied that has been indicated and the end offset of the volume thereof from the virtual storage device of the copy source, and divides a range to be copied so as to have the previously set division size on the basis of the start offset and the end offset of the read out volume. In the example illustrated in FIG. 3, the range is divided into four volume parts of a division 1 to a division 4.

The control unit 40 of the fibre channel switch Va sequentially range-locks the divided volume parts and executes data-copying thereon. FIG. 3 illustrates an example in which the volume part of the division 2 is being range-locked and data-copying is being executed thereon.

(3) The fibre channel switch Va communicates with the other fibre channel switch Vb via the LAN line to indicate a range to be range-locked.

(4) The fibre channel switch Vb that has received the indication of the range to be range-locked range-locks the volume part of the indicated range in each of the virtual storage devices A and B.

(5) Then, it is supposed that the host computer 31 has transmitted a data writing instruction to the fibre channel switch Vb after the fibre channel switch Vb has range-locked the volume part concerned.

(6) The control unit 40 of the fibre channel switch Vb compares a volume part as an object into which data is to be written in accordance with the data writing instruction with the volume part that is being range-locked, and when the volume part into which data is to be written fully or partially coincides with the volume part so range-locked, puts the data writing instruction on standby with no execution thereof.

In the case that the data writing instruction is given to the range-locked volume part and the data writing instruction is put on standby, the instruction number counting section 49 of the fibre channel switch Vb counts the number of data writing instructions given to the range-locked volume part and stores the number in the counted number storing section 51. The number of data writing instructions is counted for each of the divided volume parts.

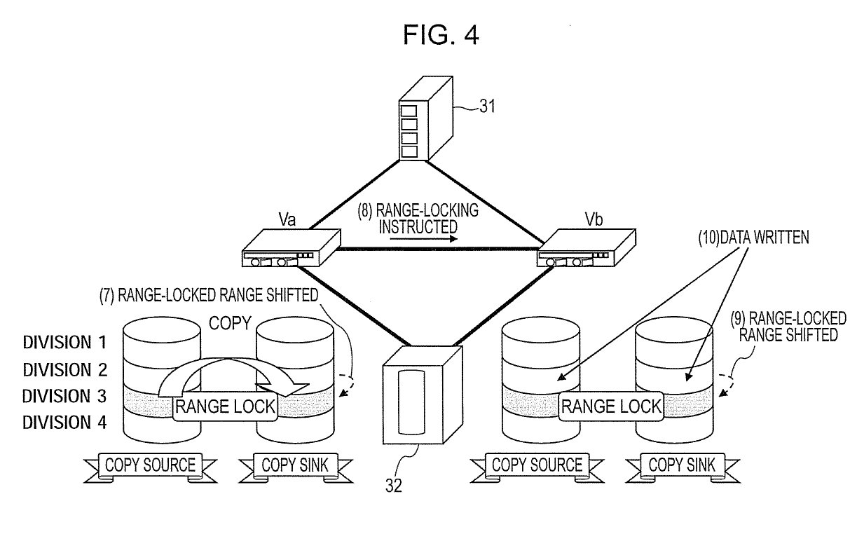

(7) In the fibre channel switch Va, at the completion of data copying on the divided volume part, the control unit 40 of the fibre channel switch Va releases range-locking set for the divided volume part for which data-copying has been completed and range-locks the next divided volume part (the division 3 in FIG. 4).

(8) The fibre channel switch Va communicates with the other fibre channel switch Vb via the LAN line to command the switch Vb to release range-locking set on the division 2 and to range-lock the division 3.

(9) The control unit 40 of the fibre channel switch Vb which has received commands to release range-locking set for the division 2 and to range-lock the division 3 releases range-locking set for the division 2 and range-locks the division 3 as indicated.

(10) In the fibre channel switch Vb, the data writing instruction which has been put on standby is executed to perform data writing on the volume part of the division 2 that has been released from range-locking.

(11) At the completion of data copying on all the volume parts to which data is to be copied in the above mentioned manner, the fibre channel switch Va transmits information on completion of data copying and a request to release range-locking to the fibre channel switch Vb via the LAN line.

(12) The fibre channel switch Vb that has received the information on completion of data copying reads out the number of data writing instructions that have been given to each of the divided volume parts and have been put on standby from the counted number storing section 51 and transmits the read-out number to the fibre channel switch Va.

(13) The divided capacity changing section 50 of the fibre channel switch Va compares the number of put-on-standby instructions that has been transmitted from the fibre channel switch Vb with the previously set threshold value.

Then, the divided capacity changing section 50 operates to increase the division size obtained when initial division is performed in the case that the counted number of instructions is less than the threshold value, while in the case that the counted number of instructions is more than the threshold value, operates to decrease the division size.

At the completion of one copying operation, the divided capacity changing section 50 operates to store the division size so changed in a memory area of the control unit 40.

After the division size has been changed, the fibre channel switch Va transmits information that the division size is to be changed to the other fibre channel switch Vb via the LAN line. In the fibre channel switch Vb, data on division size stored in the control unit 40 is changed to have the division size indicated by the fibre channel switch Va. In the above mentioned manner, changing of the division size performed upon range-locking can be applied to both of the two fibre channel switches.

Then, upon execution of the next data copying, the range to be copied can be divided into parts based on the changed division size and range-locking can be performed on the parts so divided.

In the above mentioned embodiment, in one of the two fibre channel switches, the division size has been changed. However, the division size may be changed in both of the two fibre channel switches. That is, the fibre channel switch Vb may operate to transmit the counted number of instructions to the fibre channel switch Va and to compare the counted number of instructions with a threshold value which has been previously set using the divided capacity changing section 50 installed in its own control unit 40 simultaneously therewith, thereby controlling to increase the division size obtained when initial division is performed in the case that the number of instructions is less than the threshold value or to decrease the division size in the case that the number of instructions is more than the threshold value.

Although, in this embodiment, the case where the instruction number counting section 49 counts the total number of instructions obtained until all the copying operations are completed has been described, the instruction number counting section 49 may be constructed to count the number of instructions given in a predetermined time period. By constructing as mentioned above, whether the number of instructions is more than the threshold value can be rapidly recognized before all the copying operations are completed and the division size can be rapidly changed.

In addition, in the above mentioned embodiment, the case where the division size used in a copying operation which will be executed next is changed at the completion of all the copying operations has been described. However, according to the present invention, the division size may be changed at the completion of a copying operation executed on a divided volume part of the volume to be subjected to data copying.

By constructing as mentioned above, changing of the division size on the basis of the counted number of instructions can be rapidly applied to both the fibre channel switches.

Further, in the above mentioned embodiment, the operations executed when a data writing instruction has been given from the host computer 31 while data-copying is being executed have been described. However, an instruction which will be later given from the host computer may be a data copying instruction.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A virtualizing switch, comprising:
a storage virtualizing section making a host computer recognize storage areas prepared by combining together some or all of storage areas of physical storage devices as a plurality of virtual storage devices;
a data copying section executing data copying between the virtual storage devices;
a range locking section dividing a storage area for storing data to be copied of a virtual storage device of a copy source into storage area parts having a previously set division size, and inhibiting access to a divided storage area part concerned when the data copying section executes data copying between the virtual storage devices;
an instruction number counting section counting the number of access instructions from the host computer to the divided storage area part to which access is inhibited by the range locking section; and
a divided capacity changing section changing the division size based on the number of instructions counted by the instruction number counting section.

2. The virtualizing switch according to claim 1, wherein
the divided capacity changing section changes the division size so as to increase the division size when the number of instructions counted by the instruction number counting section is less than a threshold value, and to decrease the division size when the number of instructions counted by the instruction number counting section is more than the threshold value.

3. The virtualizing switch according to claim 1, wherein
the divided capacity changing section changes the size of the next divided storage area part at the completion of data copying performed on any of the divided storage area parts.

4. The virtualizing switch according to claim 1, further comprising:
an access information notifying unit for notifying another virtualizing switch of an access state sent from the host computer via an inter-virtualizing-switch communication line connecting unit.

5. A virtualizing switch controlling method, comprising:
executing data copying among a plurality of virtual storage devices prepared using some or all of storage areas of physical storage devices;
dividing a storage area for storing data to be copied in a virtual storage device of a copy source into storage area parts having a previously set division size when data copying is executed between virtual storage devices;
inhibiting access from the host computer to a divided storage area part concerned;
counting the number of access instructions given from the host computer to the divided storage area part to which access has been inhibited; and
changing the division size based on the counted number of instructions.

6. The virtualizing switch controlling method according to claim 5, wherein
the division size is changed such that when the counted number of instructions is less than a previously set threshold value the previously set division size is increased, and when the counted number of instructions is more than the threshold value the previously set division size is decreased.

7. The virtualizing switch controlling method according to claim 5, wherein
the size of the next divided storage area part is changed at the completion of data copying performed on each of the divided storage area parts.

8. The virtualizing switch controlling method according to claim 5, wherein
an access state sent from the host computer is notified to another virtualizing switch via an inter-virtualizing-switch communication line connecting unit.
